(19) United States
(12) Patent Application Publication
(10) Pub. No.: US 2005/0131920 A1
(43) Pub. Date: Jun. 16, 2005

(54) Computer implemented methods and systems for representing multiple data schemas and transferring data between different data schemas within a contextual ontology

(76) Inventors: Godfrey Rust, London (GB); Paul Hatcher, London (GB); Mark Bide, Oxford (GB)

Correspondence Address: WILMER CUTLER PICKERING HALE AND DORR LLP, 399 PARK AVENUE, NEW YORK, NY, 10022, US

(21) Appl. No.: 10/965,175

(22) Filed: Oct. 15, 2004

Related U.S. Application Data
(60) Provisional application No. 60/511,667, filed on Oct. 17, 2003.

(51) Int. Cl. G06F 17/00

(52) U.S. Cl. 707/100

(57) ABSTRACT

Methods and systems are provided which enable users to map and transform data between different data schemas while preserving the semantic integrity of the data. In accordance with the present invention, computer implemented methods and systems are provided for separation and mapping of representational and linguistic semantics. By representing the semantic portion of the schema using a formal ontology, these methods and systems allow data to be contextually transferred between different data schemas.

### CROSS REFERENCE TO RELATED APPLICATION

This application claims the benefit under 35 U.S.C. § 119(e) of U.S. Provisional Patent Application No. 60/511,667, filed Oct. 17, 2003, which is hereby incorporated by reference herein in its entirety.

### FIELD OF THE INVENTION

The present invention generally relates to the mapping and transformation of data schemas. More particularly, the present invention relates to computer implemented methods and systems for transferring data between different data schemas while preserving the semantic integrity of the data.

### BACKGROUND OF THE INVENTION

Computer software applications employ various data types to represent and store data. These data types may be, for example, base types (e.g., integer, character, or string), derived data types including user-defined types (e.g., records or arrays), or alternatively object-oriented types, such as classes. The data types are typically implemented in a particular programming language for a particular platform. For example, XML schemas express shared vocabularies and allow machines to carry out rules defined by users. XML schemas provide an approach for defining the structure, content, and semantics of XML documents.

Known conventional software tools exist for data modeling and translation from one schema or syntactic form to another. One example of such a tool is the XML Stylesheet Language for Transformations (XSLT). Although XSLT performs transformations that move an element from one place to another and may change its representation and encoding, it does nothing to its meaning. XSLT and other such tools deal only with the formal or syntactic aspects of the transformation, and do not deal with issues related to the meaning or semantic aspects of mapping and transformation.

Semantic transformation may be described as operating on two levels. The first is the simple “one-to-one” mapping of Term A in schema A to Term B in schema B. For example, “PrimaryTitle” in schema A is equivalent to “MainTitle” in schema B. However, it is rare that schemas map to one another comprehensively in such a simple way.

At the more complex level, terms, such as Term A and Term B, may be mapped with some level of indirection. For example, “PrimaryTitle” in schema A may be mapped to “Title” in schema B because there is no direct equivalent. In another example, a term or group of terms in one schema may be “de-constructed” and represented in different components in another schema. An example of this is where schema A has a single element called “PrimaryTitle,” while schema B has an element called “Title,” which has an attribute of “Type,” for which “MainTitle” is a permitted value. The resulting transformation may give these two semantically equivalent statements: 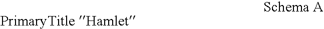 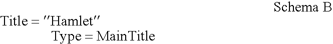
It should be noted that even the simplest level of mapping (e.g., answering the question of whether “Primary” and “Title” in schema A mean the same as “Main” and “Title” in schema B) may require a careful analysis and some degree of expertise and knowledge of the relevant domain. The more complex levels require more complex analysis. As a result, the mapping of large and specialized schemas to one another is a difficult and time-consuming process.

The level of indirection required often involves the use of some intermediate processing, and the creation of intermediate terms or elements to support intermediate steps in the transformation which do not appear in either schema A or schema B. This is made more problematic because the underlying semantic model of a schema (unlike its syntactic model) is usually non-standard and imprecisely documented. To some extent schemas can compensate for this by using standardized semantics from an agreed dictionary or set of terms. In recent years the development of ontologies, or structured data dictionaries, has begun to provide, among other things, more general common ways of relating underlying semantic structures. However, such standards and ontologies are generally limited, and most of the semantic content of a schema normally remains outside of its scope and requires arbitrary, expert, non-replicable one-to-one mapping.

Accordingly, it is desirable to provide systems and methods that overcome these and other deficiencies of the prior art.

### SUMMARY OF THE INVENTION

In accordance with the present invention, computer implemented methods and systems are provided for mapping and transforming schemas and/or data from one schema to another schema while preserving its full meaning.

In accordance with some embodiments of the present invention, in response to receiving a schema represented in its native syntax, the semantic portion of the received schema is distinguished. The schema may be, for example, an XML message schema, a relational schema, or an ObjectOriented Class model. The semantic portion may include representational semantics, conditional semantics, unconditional semantics, any suitable combination thereof, and any other suitable semantics. A contextual ontology having ontology terms is accessed and used to map the semantic portion of the received schema. In some embodiments, a single contextual ontology is accessed without accessing any additional ontologies or structured data dictionaries. Alternatively, multiple-related ontologies or distributed ontologies may also be used. The semantic portion is mapped to a constraint set using the contextual ontology. A second schema may then be determined that is responsive to the constraint set to which the semantic portion is mapped.

In some embodiments, the semantic portion of the received data may be mapped by generating a representational constraint set and generating a conditional constraint set. As used herein, a constraint set (sometimes referred to herein as a “constraining rule set” or an “ontological rule set”) is generally a set of statements and/or rules expressing logical and/or linguistic constraints on the meaning or representation of a term. The conditional constraint set includes linguistic (i.e., not formal or mathematical) semantics. The representational constraint set expresses the formal semantics of the schema. The conditional constraint set is therefore capable of expressing the semantic relationship of the schema without reference to the formal semantics of the representational constraint set in a form which lends itself to processing and transformation using other tools supported by a contextual ontology. According to some aspects of the invention, both the representational constraint set and the conditional constraint set may be defined using terms in the contextual ontology.

The conditional constraint set and the representational constraint set share common variables. By sharing variables, elements from the formal representation of the representational constraint set may be transferred to the conditional constraint set. Because each representational constraint set and conditional constraint set is itself a set in the contextual ontology, ontological statements may be made about each of them.

In some embodiments, the ontology includes ontology terms that may include an agent term signifying an entity that performs an action relating to the data, a time term signifying temporal parameters of the data, a place term signifying spatial parameters of the data, and/or a resource term signifying an entity relating to the data, and subtypes of each of these terms to any level of granularity as defined in a contextual ontology or another formal ontology.

In accordance with some embodiments of the present invention, in response to receiving the data organized according to a schema, the received data may be deconstructed into a syntactic portion and a semantic portion. The semantic portion of the data may be mapped and correlated to a second schema, thereby contextually transferring the data.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

Additional embodiments of the invention, its nature and various advantages, will be more apparent upon consideration of the following detailed description, taken in conjunction with the accompanying drawings, in which like reference characters refer to like parts throughout, and in which:

FIG. 1 is a simplified illustration of an exemplary flow for mapping and transformation of one schema to another according to some embodiments of the present invention.

FIG. 2 is a simplified illustration of a context model in accordance with some embodiments of the present invention.

FIG. 3 is an example of the interrelations between the entities of a context model in accordance with some embodiments of the present invention.

FIG. 4 is an example of an adapting event in accordance with some embodiments of the present invention.

FIG. 5 is a simplified flowchart illustrating the steps performed in the mapping and representation of a schema in accordance with some embodiments of the present invention.

FIG. 6 is a simplified flowchart illustrating the steps performed in using the mapped schema to transform received data to a representational constraint set and a conditional constraint set in accordance with some embodiments of the present invention.

FIG. 7 is a simplified flowchart illustrating the steps performed in transforming data from a conditional constraint set to a specific schema representation in accordance with some embodiments of the present invention.

FIG. 8 is a schematic diagram of an illustrative system suitable for implementation of an application that uses the contextual ontology to represent different schemas and/or transform data from one schema to another schema in accordance with some embodiments of the present invention.

FIG. 9 is a detailed example of the server and one of the workstations that may be used in accordance with some embodiments of the present invention.

### DETAILED DESCRIPTION OF THE INVENTION

The following description includes many specific details. The inclusion of such details is for the purpose of illustration only and should not be understood to limit the invention. Moreover, certain features which are well known in the art are not described in detail in order to avoid complication of the subject matter of the present invention. In addition, it will be understood that features in one embodiment may be combined with features in other embodiments of the invention.

In accordance with the present invention, systems and methods for representing multiple different data schemas (for example, XML messages, Object Oriented Class models, or database schemas) may be established within a formal ontology with certain characteristics (sometimes referred to herein as the “contextual ontology”). More particularly, systems and methods for a formal separation and mapping of representational and linguistic semantics and for representing the semantics of a data schema or schema within a formal ontology, using only the terms of that ontology, are provided.

As described above, recently developed ontologies have begun to provide more general ways of relating underlying semantic structures, but are generally limited and tend to require arbitrary, expert, non-replicable one-to-one mapping. However, the one exception to this is a “contextual ontology” based on the implementation of the “context model” described in U.S. Patent Application Publication No. 2003/0221171 A1, which is hereby incorporated by reference herein in its entirety. Such an ontology is designed to represent all semantics of a schema within a rich and flexible ontological structure based on a “contextual” (or an event-driven) view of information. These representations may be embodied in sets of statements which together provide a complete representation of the semantics of a given schema. Such a contextual ontology may be used to support the “de-construction” and “re-construction” of semantics to support the transformation between different schemas, as illustrated with the simple example of “Hamlet” described above. Because the context model is exceptionally rich, it may act as an intermediate step in the transformation of data between many different types of schema. Thus, instead of each schema having to be mapped to each other within a domain, it may be mapped to the contextual ontology, which provides then a semantic “translation tool” to each other mapped schema, thereby acting as a “hub” for the many-to-many mapping of schemas.

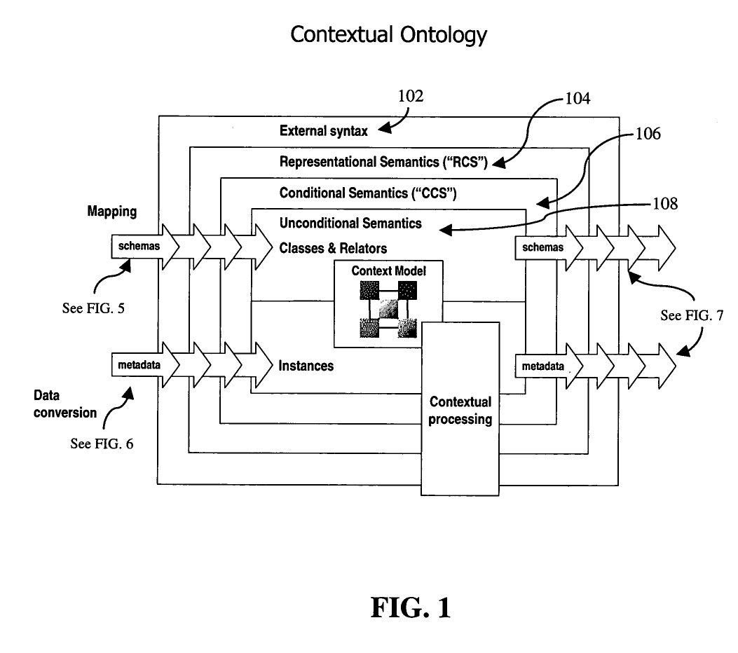

The essential methodology of the contextual ontology is the subject of above-referenced U.S. Patent Application Publication No. 2003/0221171 A1. In some embodiments, the present invention may be a supporting step in that process. Systems and methods whereby data in a schema can be analyzed and represented for use within contextual ontology are provided. In particular, the systems and methods separate the syntactic elements from the semantic elements, through the successive analysis and representation of a schema in two ways: a representational constraint set (RCS), followed by a contextual constraint set (CCS), which may then be processed in a generic way. The original process may then be reversed to embody the semantics in another syntactic schema. This process is generally represented graphically in FIG. 1.

FIG. 1 is an illustration of an exemplary flow according to some embodiments of the present invention. As shown in FIG. 1, there are three different kinds of semantics that are inherent in the representation of a data element are separated after removing the external syntax 102. The three kinds of semantics are: unconditional semantics 104 (i.e., what a data element always means), conditional semantics 106 (i.e., what the element also means in a particular expression), and representational semantics 108 (i.e., how the element is represented within a group of other elements).

The first two kinds of semantics—i.e., unconditional semantics 104 and conditional semantics 106—may be grouped for convenience under the term “linguistic semantics” to distinguish them from representative semantics, and also the logical or mathematical semantics inherent in computing processes. A “linguistic semantic” is a meaning that requires some element of human agreement or standardization if it is to be transferred from one system to another automatically: for example, two parties need to agree (directly or indirectly) that their computer systems embody the same meaning of the word Surname if a computer system used by one of them is to accurately process data provided by a system used by the other containing a value of the term Surname. In a further example, two parties may agree that the same term Surname as used one embodies the same meaning as the term FamilyName used by the other. In yet another example, two parties speaking different languages may agree that the term Bread used by one embodies the same meaning as the term Pain used by the other. This illustrates that the agreement on common linguistic semantics concerns the meaning of a term, not the name, identified or label used to denote that meaning.

Representational semantics are expressed as sets of relationships known as Representative Constraint Sets (RCSs). Conditional semantics are expressed as sets of relationships known as Conditional Constraint Sets (CCSs). These two are integrated through the sharing of common variables known as ArbitraryValues. These three constructs and their relationships embody the main aspects of the present invention.

A particular kind of ontology or structured data dictionary sometimes referred to herein as a “contextual ontology” is used. The underlying model of the contextual ontology, sometimes referred to herein as the “context model,” provides a means of integrating the semantics of data elements to any level of specialization of granularity, and provides an approach for transforming the conditional semantics. The particular expression of the context model and its extension into the contextual ontology referred to in this application is a specific application of the context model architecture which is the subject of U.S. Patent Application Publication No. 2003/0221171 A1, which is incorporated by reference herein in its entirety.

It should be noted that the present invention is based on semantic and syntactic distinctions and is not based on any specific computational model, but on the separation and combination of different representations of the semantics of schema and data elements. To implement the method, computational tools are required, but these may employ technology which already exists or is in development, and the present invention does not rely upon any of them. However, it should also be noted that while the present invention may be dependent on a number of specific existing methods or conventions, it is not essential that the present invention conform exactly to the specific syntax of these methods. Nevertheless, a consistent syntax is used herein to avoid overcomplicating the drawings and tables.

Triples

In accordance with some embodiments of the present invention, the data may be represented as statements in the form of “triples” or ternary relationships. The three elements of a triple in this ontology are named in keeping with the conventions of some computing languages:

| | |
|---|---|
| Domain | The subject of the relationship |
| Relator | The term describing the relationship between subject and object |
| Range | The object of the relationship |

It should be noted that in other languages the Relator may be referred to as a “predicate” or a “property,” and the Domain and Range as the “subject” and “object” respectively.

Examples of triples may be, for example:

| | | |
|---|---|---|
| John | IsHusbandOf | Mary |
| ISBN123456789 | HasDateOfPublication | 1996-03-04 |
| London | IsCapitalOf | UnitedKingdom |
| Creator | IsSubClassOf | Agent |

The first three of these examples are generally referred to as “instance” triples, which relate instances of data which may appear in any suitable database or message. Alternatively, the last example is an example of a “class” triple, in which two classes of things are related. Class relationships of this kind are considered a fundamental ontological relationship.

Other examples of these terms are described, for example, in the tables appended to U.S. Provisional Patent Application No. 60/511,667, filed Oct. 17, 2003, which is hereby incorporated by reference herein in its entirety.

Unconditional Triples

In some embodiments, some triples stand alone in the contextual ontology as statements and do not need to be qualified by other statements. Such triples are true everywhere and always without other conditions according to a particular ontology. These triples are sometimes referred to herein as “unconditional” triples.

For example, the ontological statements:

| | | |
|---|---|---|
| Male | IsDisjointWith | Female |
| Identifier | IsSubClassOf | Name |
| IsCreatorOf | HasDomain | Creator |

are always true according to the user or party that asserts them. It should be noted that in other ontologies, these statements may be untrue. For example, another ontology may support a world view that the same individual may be both Male and Female at the same time. This situation does not create a problem for the contextual ontology because it assumes that any statement may be held as true (asserted) by someone and as false (denied) by someone else.

Classes and Instances

In some embodiments, an ontological distinction is made between elements which are “classes” and elements which are “instances” of classes. Such a distinction is fundamental in many branches of computing. A class is a set of individuals with some common attribute(s); an instance is one of those individuals. For example, Thomas Jefferson, Richard Nixon, Henry Ford, Florence Nightingale are all instances of the class “human being”; only the first three are instances of the class “male human being”; only the first two are instances of the class “President of the United States”; only Jefferson is an instance of the class “Presidents who completed their full terms”; and so on. The number of possible classes is infinite, and one entity may be a member of any number of them.

Alternatively, classes may also be instances of other classes. For example, the class “President of the United States” is an instance of the class “Types of Heads of State.” While some computing paradigms require an absolute disjunction between class and instance, it should be noted that they are not ontologically disjoined.

Identity

These embodiments generally rely on the persistence of identity of data elements and (like any computing process) the elimination of ambiguity. Each element of data processed must have, or must be capable of being assigned, a unique identity which it preserves throughout the process. In some embodiments, an identifier is assigned which has a unique name represented by a string which is lexically unique. It should be noted that identity persists only within a prescribed domain or process, and needs to persist only as long as that domain or process persists. For example, a set of vehicle registration numbers must be unique within the territory in which they are issued; but it does not violate their identity if a UK registration number (for example, “ABC 123”) is the same literal string as a Dutch registration number, or the catalogue number of a product in a clothing store. Provided the domain (in this case, UK registration numbers) is formally designated identity can be secured.

ArbitraryValues

An ArbitraryValue is an identifier of a “variable” used in a triple to represent an unknown instance of something. In some embodiments, the syntax used is represented as #n where “n” is a number (though any consistent syntax might be used). For example,

| | | |
|---|---|---|
| “Hamlet” | HasAuthor | #1 |

This represents the statement that the entity represented by “Hamlet” has an Author, whose identity (at this point at least) is unknown. A further statement may be added to this, such as, for example:

| | | |
|---|---|---|
| “Hamlet” | HasAuthor | #1 |
| #1 | IsAuthorOf | “Cymbeline” |

The additional statement states that “whoever is the Author of Hamlet is also the Author of Cymbeline.”

Where multiple possible real values of an ArbitraryValue exist, the #n notation may be expanded to #n.n:

| | | |
|---|---|---|
| “Hamlet” | HasAuthor | #1.n |

By default, an ArbitraryValue is unique only within the Set of triples within which it appears.

Ontology Terms

Some embodiments distinguish generally between “instance data” (i.e., the elements and sets of data which exist in real world schemas that may be transformed into new instance sets as a result of the present invention) and “ontology terms”—the Classes, Relators and Sets that provide the semantic network that enables mapping and transformation. However, it should be noted that the distinction is only a general one and not absolute because:
(a) some instance data will be established in the contextual ontology as terms: for example, standard identities of instances of Languages, Currencies and Territories are published as ISO standard lists, and are commonly included in ontologies;
(b) as noted above, more or less any term, even if it is a class, can itself be an instance of another class, and so may be treated as instance data in a schema.
   The distinction is always valid in the sense that the ability to perform transformations is dependent on the semantics of ontology terms, not instance data.

Sets

A set of triples may be identified as a term in the contextual ontology. By this means, a set may be incorporated into the contextual ontology, not merely “mapped to it.” Because it is a part of the contextual ontology, described using only the syntax and semantics of the contextual ontology, a set may be processed with whatever tools are available for processing the contextual ontology.

The Contextual Ontology

Some embodiments of the present invention result in data schemas being represented within a particular kind of ontology. A computable ontology is described thus in the Wikipaedia (http://en.wikipedia.org):
“In computer science, an ontology is the attempt to formulate an exhaustive and rigorous conceptual schema within a given domain, a typically hierarchical data structure containing all the relevant entities and their relationships and rules (theorems, regulations) within that domain. The computer science usage of the term ontology is derived from the much older usage of the term in philosophy, where it means the study of being or existence as well as the basic categories thereof.”
   A contextual ontology is an ontology whose structure is based on the context model as described in above-mentioned U.S. Patent Application Publication No. 2003/0221171 A1.

The Context Model

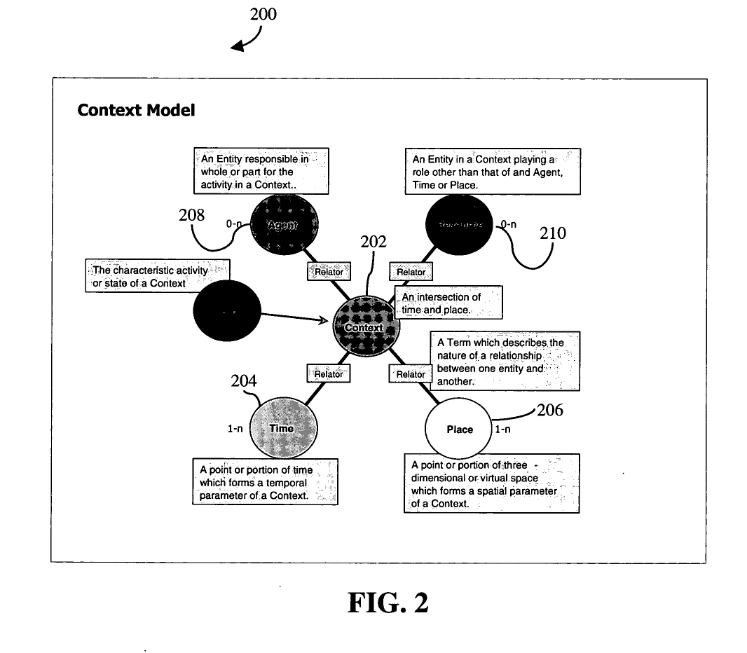

Meaning in the Contextual Ontology is based on a group of entities which are related to one another through a formal Context Model. As shown in FIG. 2, the five primitive entities of a contextual ontology 200 are context 202, time 204, place 206, agent 208, and resource 210. These entities are generally defined herein as:

| Entity | Definition |
|---|---|
| Context | An intersection of time and place. |
| Time | A point of portion of time which forms a temporal parameter |
| | of a Context. |
| Place | A point of portion of three-dimensional or virtual space which |
| | forms a spatial parameter of a Context. |
| Agent | An Entity responsible in whole or part for the activity in a |
| | Context. |
| Resource | An Entity in a Context playing a role other than that of an |
| | Agent, Time or Place. |

Relators

Each of the roles of the context model is linked to the Context with a Relator, which describes the nature of the Relationship between them:

| Class | Relator | Class |
|---|---|---|
| Context | icoAgent | Agent |
| Context | icoResource | Resource |
| Context | icoTime | Time |
| Context | icoPlace | Place |
| Agent | IsAgentInContext | Context |
| Resource | IsResourceInContext | Context |
| Time | IsTimeInContext | Context |
| Place | IsPlaceInContext | Context |

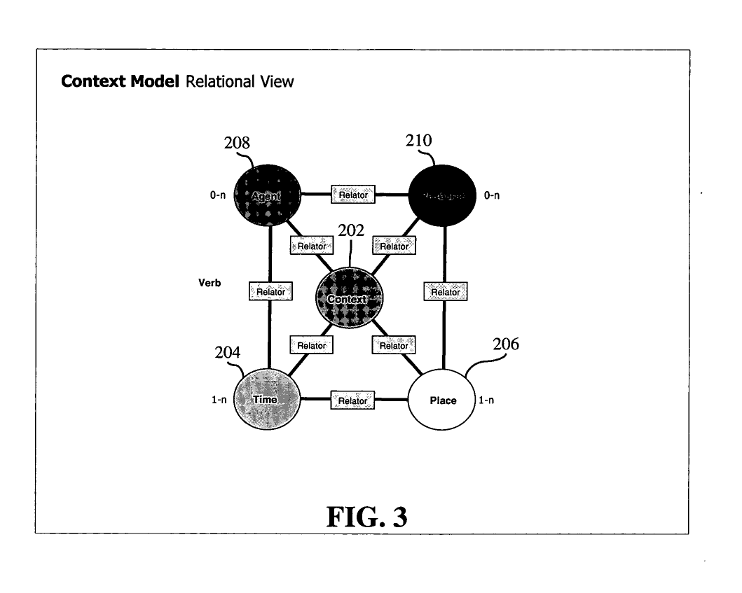

In addition, brought together through their relationship with the context, the roles also establish relationships with one another, as shown in FIG. 3.

These relationships might be named in this way:

| Class | Relator | Class |
|---|---|---|
| Agent | HasCoAgent | Agent |
| Agent | IsAgentActingOn | Resource |
| Agent | IsAgentAtTime | Time |
| Agent | IsAgentInPlace | Place |
| Resource | IsActedOnBy | Agent |
| Resource | HasCoResource | Resource |
| Resource | IsResourceAtTime | Time |
| Resource | IsResourceInPlace | Place |
| Time | IsTimeOfActingBy | Agent |
| Time | IsTimeOfResource | Resource |
| Time | HasCoTime | Time |
| Time | IsTimeInPlace | Place |
| Place | IsPlaceOfActingBy | Agent |
| Place | IsPlaceOfResource | Resource |
| Place | IsPlaceAtTime | Time |
| Place | HasCoPlace | Place |

This set of relationships (the “Relational View”) completes the semantics of the primitive context model. The collection of Classes and Relators supporting a single context is called a “context family.” A context family relator implicitly carries the identity of the two classes it joins. This means that in any statement of the form (for example):

| | | |
|---|---|---|
| #1 | IsResourceInPlace | #2 |

it is implicit that the instance #1 is a Resource and the instance #2 is a Place. The “context family” relationships may be grouped in a Set called a “Conditional Constraint Set” or “CCS” which together makes up the sum of the “conditional constraints” of a Context:

| | | |
|---|---|---|
| #1 | icoAgent | #2.n |
| #1 | icoResource | #3.n |
| #1 | icoTime | #4.n |
| #1 | icoPlace | #5.n |
| #2.n | IsAgentInContext | #1 |
| #2.n | HasCoAgent | #2.m |
| #2.n | IsAgentActingOn | #3.n |
| #2.n | IsAgentAtTime | #4.n |
| #2.n | IsAgentInPlace | #5.n |
| #3.n | IsResourceInContext | #1 |
| #3.n | IsActedOnBy | #2.n |
| #3.n | HasCoResource | #3.m |
| #3.n | IsResourceAtTime | #4.n |
| #3.n | IsResourceInPlace | #5.n |
| #4.n | IsTimeInContext | #1 |
| #4.n | IsTimeOfActingBy | #2.n |
| #4.n | IsTimeOfResource | #3.n |
| #4.n | HasCoTime | #4.m |
| #4.n | IsTimeInPlace | #5.n |
| #5.n | IsPlaceInContext | #1 |
| #5.n | IsPlaceOfActingBy | #2.n |
| #5.n | IsPlaceOfResource | #3.n |
| #5.n | IsPlaceAtTime | #4.n |
| #5.n | HasCoPlace | #5.n |

For any Context, each of these statements is true for all real values of each ArbitraryValue.

Adding Terms to the Contextual Ontology

In addition to its four basic role types of Resource, Agent, Time and Place, a Context is an instance of a Verb (or an “Act”). New meanings are primarily introduced into a Contextual Ontology through Verbs. The introduction of a single concept such as Adapt is mediated into dozens of new ontology Terms through the Context Model relationships.

A Contextual Ontology is extended on the Context Model using standard formal ontological axioms such as subsumption, partition, disjunction, classification and equivalence. The combination of these axioms with those of the Context Model creates a “semantic scaffolding,” a grid of meaning into which any Term or schema may be mapped.

For example, following a descending hierarchy of Verbs such as this:

Act
Do
   Make
      Create
         CreateFrom
         Adapt
            there exists a Context Family defined for the Verb Adapt:

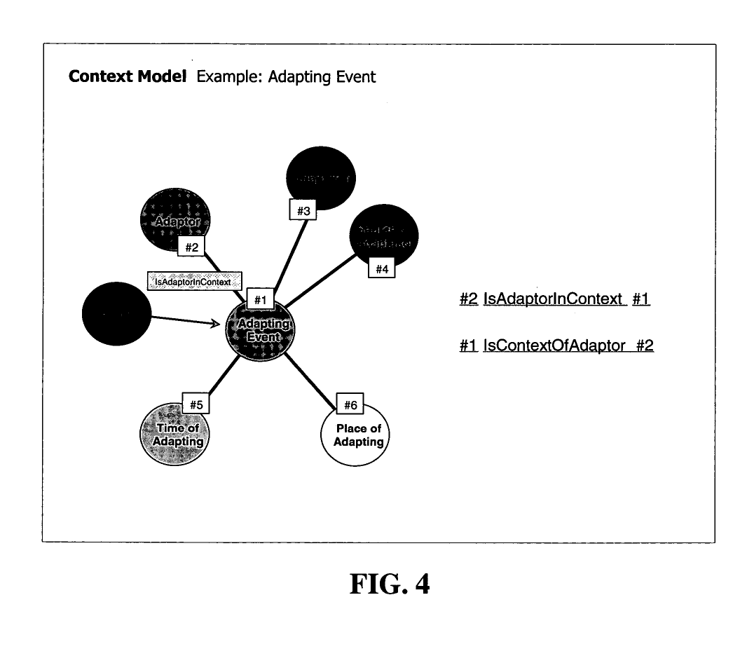

FIG. 4 shows the types of Agent, Resource, Time and Place for the simplest Adapting event. Just as Adapt is a descendent of Act, so AdaptingEvent is a descendent of Context, Adaptor a descendent of Agent, Adaptation and SourceOfAdaptation are descendents of Resource, and so on. Each verb that is added to the verb hierarchy results in new branches to the “trees” growing down from Agent, Resource, Time and Place.

The same model applies to the Relators: each Relator is unique, and is descended from one of the original Relators from the Context Model itself. FIG. 4 includes the statements which are true for this ContextFamily, which is quite extensive. The values in FIG. 4 (Modified, EditedBy, IsVersionOf etc) which are shown superimposed onto the list of Relators are there to provide examples of data elements of the kind which commonly appear in real schemas, and which in fact have an equivalent meaning to the Relators of the “Adapt” Context Family shown here.

These examples illustrate the way that commonplace semantics are located within the structure of a contextual ontology. All Terms in a Contextual Ontology exist somewhere within a Context, however complex it may be.

Contextual Transformation by Substitution of ArbitraryValues

The contextual structure of a contextual ontology, with its reliance on a comprehensive set of defined relators for every context, enables triple statements that are made in one form to be transformed into another form by automated means. One example of this is the transformation between a contextual view (for example, the attributes of an event) and a relational view (for example, the attributes of a Resource). Given the following statements about an event (“Event 1”) in which an adaptation was made:

| | | |
|---|---|---|
| Event1 | icoAdaptor | Agent1 |
| Event1 | icoAdaptation | Resource1 |
| Event1 | icoSourceOfAdaptation | Resource2 |
| Event1 | icoTimeOfAdaptating | Time1 |
| Event1 | icoPlaceOfAdaptating | Place1 |

then by substitution of these values for the ArbitraryValues throughout the context family, using the set of statements shown in FIG. 4, the following statements are all true, for example, about Resource1:

| | | |
|---|---|---|
| Resource1 | IsAdaptedFrom | Resource2 |
| Resource1 | IsAdaptedBy | Agent1 |
| Resource1 | IsAdaptedAtTime | Time1 |
| Resource1 | IsAdaptedInPlace | Place1 |
| Resource1 | IsAdaptationInContext | Event1 |

Similar groups of statements can be made about each of the other entities in Event1. The example quoted is a typical example of transforming data from “workflow” (event-based) data into “bibliographic” (resource-based) data.

Application of Further Computing Techniques

A wide variety of computing techniques may be used to make and support such transformations. For example, if the computing program used employs an inference technique based on parent-child subsumption of the kind supported by Description Logics (as exemplified by the axiom “owl:subClass” in the ontology language OWL-DL) then the original statements might be written in a much more generalized form, drawing on a range of relators from different Context Families above Adapt in the ontology hierarchy:

| | | |
|---|---|---|
| Event1 | icoAgent | Agent1 |
| Event1 | icoAdaptation | Resource1 |
| Event1 | icoSource | Resource2 |
| Event1 | icoTime | Time1 |
| Event1 | icoPlaceOfMaking | Place1 |

However, even using such computing would still yield the same transformation results by determining the identity of the most specialized relator in the Set (icoAdaptation) and specializing every other relator to the same context.

Implementation of Contextual Transformation

The examples given above are illustrations which demonstrate the potential scope of contextual transformation based on an ontology with the structure of a Contextual Ontology. However, one of the problems of implementing such methods is the requirement for processes which will render instance data into a form suitable for contextual transformation (or any other computing process supported by a Contextual Ontology). That is one of the problems addressed by the present invention.

Expression of a Schema as a Representational Constraint Set (RCS)

The first step is to represent a schema in the form of a Representative Constraint Set or “RCS,” employing the elements described earlier. As used herein, an RCS is a set of Triples and TripleSets which expresses the syntactic structuring and labeling of a group of data elements. For example, a very simple message (“Message1”), originally expressed in XML, may contain the details of the title and author of an article published in a journal:

| | | |
|---|---|---|
| Message1 | HasElement | #1 |
| #1 | HasName | Title |
| #1 | HasCardinality | *1 |
| #1 | HasDataType | VarChar50 |
| #1 | HasXmlAttribute | #2 |
| #2 | HasName | Type |
| #2 | HasCardinality | *1 |
| #2 | HasDataType | AllowedValue |
| Message1 | HasElement | #3.n |
| #3 | HasName | Author |
| #3 | HasMaxCardinality | *4 |
| #3 | HasDataType | VarChar50 |

This RCS representation shows that the Message contains three data elements (represented by #1, #2 and #3.n). The Message may be interpreted as follows:

| | | |
|---|---|---|
| Message1 | HasElement | #1 |

Message1 contains a data element represented here by #1.

| | | |
|---|---|---|
| #1 | HasName | Title |

This element is called “Title”.

| | | |
|---|---|---|
| #1 | HasCardinality | *1 |

This element occurs once and once only in Message1.

| | | |
|---|---|---|
| #1 | HasDataType | VarChar50 |

The value of this element is represented as an alphanumeric string of any
length up to 50 characters.

| | | |
|---|---|---|
| #1 | HasXmlAttribute | #2 |

The “Title” has an attribute, which is represented in XML as an attribute,
and represented here by #2.

| | | |
|---|---|---|
| #2 | HasName | Type |

This attribute of “Title” is called a “Type”.

| | | |
|---|---|---|
| #2 | HasCardinality | *1 |

This attribute occurs once and once only for a “Title”.

| | | |
|---|---|---|
| #2 | HasDataType | AllowedValue |

The value of this attribute is one of a set of values contained in an
established list.

| | | |
|---|---|---|
| Message1 | HasElement | #3.n |

Message1 contains a data element represented here by #3.n.

| | | |
|---|---|---|
| #3.n | HasName | Author |

This element is called “Author“”.

| | | |
|---|---|---|
| #3.n | HasMaxCardinality | *4 |

This element occurs a maximum of four times.

| | | |
|---|---|---|
| #3.n | HasDataType | VarChar30 |

The value of this element is represented as an alphanumeric string of any length up to 30 characters.
It should be noted that the use of the asterisk * before certain values is a syntactic convention to indicate that their datatype is that of a number.

Multiple Occurrences of Elements in RCS

The inclusion of “.n” to ArbitraryValue “#3.n” reflects the fact that this element may occur more than once. “#3.n” is a syntactic shorthand which indicates that each individual occurrence would be named “#3.1”, “#3.2”, etc. For the sake of completion, and to demonstrate that this does not violate the principle that all semantics in the Method are captured in triples, this shorthand of this fragment:

| Message1 | HasElement | #3.n |
|---|---|---|
| #3 | HasName | Author |
| #3 | HasMaxCardinality | *4 |
| #3 | HasDataType | VarChar50 |

is expanded systematically thus when processing:

| | | |
|---|---|---|
| Message1 | HasElement | #3.1 |
| #3.1 | HasName | Author |
| #3.1 | HasCardinality | *1 |
| #3.1 | HasDataType | VarChar30 |
| Message1 | HasElement | #3.2 |
| #3.2 | HasName | Author |
| #3.2 | HasMinCardinality | *0 |
| #3.2 | HasMaxCardinality | *1 |
| #3.2 | HasDataType | VarChar30 |
| Message1 | HasElement | #3.3 |
| #3.3 | HasName | Author |
| #3.3 | HasMinCardinality | *0 |
| #3.3 | HasMaxCardinality | *1 |
| #3.3 | HasDataType | VarChar30 |
| Message1 | HasElement | #3.4 |
| #3.4 | HasName | Author |
| #3.4 | HasMinCardinality | *0 |
| #3.4 | HasMaxCardinality | *1 |
| #3.4 | HasDataType | VarChar30 |

Because data elements often have an unlimited potential number of occurrences, it is self-evident that an expansion of this type can only be made when dealing with finite real instances.

“Chaining” of RCSs

One RCS may refer to another RCS as an Element, and this may be extended to any level of granularity, as in this example:

| | | |
|---|---|---|
| Message1 | HasElement | Message2 |
| Message2 | HasMinCardinality | *1 |
| Message2 | HasElement | Message3 |
| Message3 | HasMinCardinality | *1 |
| etc. | | |

This mechanism (described as “Chained Sets”) enables schemas to be built up of any number of Sets of triples.

RCS Formal Semantics

The only semantics contained in an RCS are formal: they concern the form in which an element is represented and related, but importantly tell nothing at all about the meaning of the element itself. In the example quoted, although the elements have names of “Title,” “Author,” and “Type,” the RCS provides no computable information about what these represent. These names might as well be spelled backwards as “Eltit”, “Rohtua” and “Epyt” for all the inherent semantic value they offer to a computer.

On the other hand, the formal semantics used in an RCS (such as HasElement, HasMinCardinality or VarChar3) are all Terms in a Contextual Ontology which have interpretable formal meaning as a result of prior mapping using syntactic mapping tools. For example, the Relator HasMinCardinality may be mapped through an XSLT stylesheet so that it corresponds to the element “MinOccurs” in an XML Schema, and this mapping can therefore support the formal conversion of a schema from XML document form to RCS form. Tools like XSLT for supporting such formal transformations between different formal schemas are commonplace. They may be used with the present invention to support the formal creation and external interpretation of an RCS, but do not in themselves form any part of the present invention.

Such a transformation says nothing at all about the meanings of the elements which are being mapped. The alphanumeric strings “The Merchant Of Venice” and “William Shakespeare” may have the labels “Title” and “Author”, and may be presented in different type styles and fonts, or represented in triples or in binary relationships in a database table, but without further encoding no computer can determine anything at all about the classes of things which they represent, or their relationships.

There are complex and considerable issues involved in the definition of formal and representative semantics, and their mappings are supported by the methodology of a Contextual Ontology, but these are outside the scope of the Method, which assumes an accurate formal representation of a schema in an RCS.

These are the principal representative Relators used in an RCS:

HasElement
HasCardinality
HasMinCardinality
HasMaxCardinality
HasDatatype
HasName
HasValue

These Relators are all Terms in the Contextual Ontology. Others may be added to this list, and these may specialized to any degree required by an external schema. For example, these are additional Relators which may be used in an RCS specialized to conform to the requirements of an XML Schema:

HasXmlAttribute
HasXmlChoice

or for an ObjectOriented Class model:

HasOOAttribute
HasOOAssociation

Example of an RCS Including Data Values

This example includes illustrative real values (highlighted in red) for an instance of Message1:

| | | |
|---|---|---|
| Message1 | HasElement | #1 |
| #1 | HasValue | “Ontological agreement” |
| #1 | HasName | Title |
| #1 | HasCardinality | *1 |
| #1 | HasDataType | VarChar50 |
| #1 | HasXmlAttribute | #2 |
| #2 | HasValue | xyz: MainTitle |
| #2 | HasName | Type |
| #2 | HasCardinality | *1 |
| #2 | HasDataType | AllowedValue |
| Message1 | HasElement | #3.4 |
| #3.1 | HasValue | “Jill Smith” |
| #3.n | HasName | Author |
| #3.n | HasMaxCardinality | *4 |
| #3.n | HasDataType | VarChar50 |

This example assumes that the allowed value of #2 is drawn from a namespace called “xyz”.

Expression of the Semantics of a Schema as a Conditional Constraint Set (CCS)

The second step is the creation of a Conditional Constraint Set or “CCS” which, as used herein, expresses the semantic relationships of the elements in a schema without reference to their representation. Where an RCS is “form without meaning,” a CCS is “meaning without form.” This separation is the heart of the Method described here. It allows the semantics of any schema to be rendered, through the steps of RCS and CCS, into a form which is computable making use of the context model described in U.S. Patent Application Publication No. 2003/0221171 A1.

A CCS is a set of Triples describing the semantic relationships that exist between instances. For example, here is the CCS that represents the underlying semantics of the “Message1” schema expressed earlier as an RCS.

| | | |
|---|---|---|
| #4 | IsA | JournalArticle |
| #4 | HasTitle | #1.n |
| #1.n | HasType | #2 |
| #4 | HasAuthor | #5.n |
| #5.n | HasName | #3.n |

This may be interpreted as follows:

| #4 | IsA | JournalArticle |
|---|---|---|
| Something exists which is a JournalArticle. | | |
| #4 | HasTitle | #1.n |
| This JournalArticle has any number of Titles. | | |
| #1.n | HasType | #2 |
| Each Title of the JournalArticle has a single Type. | | |
| #4 | HasAuthor | #5.n |
| This JournalArticle has any number of Authors. | | |
| #5.n | HasName | #3.n |

Each Author has at least one Name.

The object of a CCS is to represent completely the linguistic semantics of the Term or schema. This is done in a series of conditional statements using Terms drawn entirely from the contextual ontology. Any Terms that are required but not present in the contextual ontology are first added to the ontology in the normal manner, and then employed in the CCS.

Most CCS semantics are communicated through Relators, as in the example above. Because of the “Context Family” semantic model, it is possible to define and use Relators of any level of specialization which convey the most precise semantic information about the Domain and Range of the Triple in which they appear. For example, the CCS example above might be made even shorter by combining the first two Triples using a Relator such as:

| | | |
|---|---|---|
| #4 | HasJournalArticleTitle | #1.n |

which would convey the meaning that #4 is a Journal Article, as well as the meaning that #1.n is its Title. By substitution and pattern matching within the contextual semantics of a Contextual Ontology a system can infer the statements:

| | | |
|---|---|---|
| #4 | IsA | JournalArticle |
| #4 | HasTitle | #1.n |

Each of the Terms used in this example:

JournalArticle
IsA
HasTitle
HasType
HasAuthor
HasName

is a Term in the Contextual Ontology which either belongs to a Context Family, or is a SubType of a member of a Context Family, and can therefore be “contextualized” for processing. Any Term in the Contextual Ontology may be used in a CCS, and if the required terms do not exist, they may be defined within the Contextual Ontology in the normal way.

Corresponding Values Between RCS and CCS

The link between RCS and CCS is their sharing of common ArbitraryValues: “#1” in the RCS identifies the same entity as “#1” in the CCS. This provides the mechanism for the migration of elements from the formal representation of RCS to the semantic representation of CCS. Because each RCS and CCS is itself a Set in the Contextual Ontology, ontological statements may be made about it. The relationship between an RCS/CCS “pair” of Sets is established in the Contextual Ontology by a triple in this form:

| | | |
|---|---|---|
| RCS#1 | SharesValuesWith | CCS#1 |

Every ArbitraryValue which exists in an RCS must be represented in its corresponding CCS. However, additional ArbitraryValues may be added in a CCS (as in the example quoted above) which are not explicit but merely implicit in the RCS.

There is another method for establishing the identity of ArbitraryValues between two sets. This is used, for example, where an RCS contains other “nested” RCSs. These RCSs may have been created independently and therefore have ArbitraryValue ranges which overlap and conflict (for example, #1 in one RCS will not represent the same element as #1 in another). If it is necessary to establish a mapping between two such sets it may be done with a CorrespondingValueSet which maps identities with a Set of Triples as in this example:

| Message1 | HasCorrespondingValuesWith | Message2 |
|---|---|---|
| #1 | IsEquivalentTo | #4 |
| #2 | IsEquivalentTo | #6 |

The example states that the Element Value represented by #1 in Message1 is the same as the Element Value #4 in Message2, and so the Value of one may be substituted for the Value of the other.

Methodology for Establishing a CCS

A CCS is established by analysis of an RCS and the schema it represents, and the expression of the semantics represented by that schema in the Method's Triple form. All Relators used in Triples in a CCS may be drawn from the Contextual Ontology being used to support the Method. Any logical or defined semantic relationship may be employed. The objective is to represent the underlying semantics of the RCS. This process is illustrated in an example with reference to the fragment of an RCS and CCS quoted above.

The RCS fragment in question contains three elements (#1, #2 and #3) representing (according to their names) a “Title”, “Author” and “Type”. The first semantic question is, of what entity is each of these an attribute? The RCS provides no logical reason to infer any relationship between them: they are all simply elements in a Message. Human analysis tells us (presumably from reading the supporting documentation of the Message) that all these three elements are attributes of an instance of a journal article. Note that although the whole Message is about a journal article, the RCS itself contains no explicit reference to it.

The CCS therefore starts by declaring the existence of this instance:

| | | |
|---|---|---|
| #4 | IsA | JournalArticle |

Meaning: Something exists which is a JournalArticle.
(We assume here that the Term “JournalArticle”, and the other Terms used in this example, have been satisfactorily defined in the Contextual Ontology by the normal processes).

Now it can be seen that the “Title” element (#1) belongs to the JournalArticle and this is added to the CCS:

| | | |
|---|---|---|
| #4 | IsA | JournalArticle |
| #4 | HasTitle | #1.n |

Meaning: This JournalArticle has any number of Titles.

Now it can be seen that the “Type” element (#2) belongs not to the JournalArticle but to the Title:

| | | |
|---|---|---|
| #4 | IsA | JournalArticle |
| #4 | HasTitle | #1.n |
| #1.n | HasType | #2 |

Meaning: Each Title of the JournalArticle has a single Type.

Finally we consider the “Author” element (#3). It can be seen that the element in the RCS is not the “Author”, but the Author's Name (or one of the Author's names). The “Author” is not actually referenced directly in the RCS, so a new element (#5) is needed to represent the Author(s). The Author is directly associated with the JournalArticle:

| | | |
|---|---|---|
| #4 | IsA | JournalArticle |
| #4 | HasTitle | #1.n |
| #1.n | HasType | #2 |
| #4 | HasAuthor | #5.n |

Meaning: This JournalArticle has any number of Authors.

Then, the AuthorName is directly associated to the Author:

| | | |
|---|---|---|
| #4 | IsA | JournalArticle |
| #4 | HasTitle | #1.n |
| #1.n | HasType | #2 |
| #4 | HasAuthor | #5.n |
| #5.n | HasName | #3.n |

Meaning: Each Author has at least one Name.

By this analytical process a CCS is completed which represents the whole meaning of the statements in the RCS, but is separated from its specific representation: it is now represented wholly in terms of the semantics of the Contextual Ontology. If real data values are substituted for ArbitraryValues in this CCS, it may be processed in any way and for any purpose supported by the Contextual Ontology, including a process of contextual transformation which might enable this data to be represented using another CCS which shares its values with another RCS, thereby enabling the transfer of meaning from one schema to another.

Note that the process of expert human analysis illustrated above is not a part of the present invention. The present invention lies in the means of representation of the results of such an analysis in a form which separates the analyzed semantics from their representational form.

Passing Data Values from an RCS to a CCS

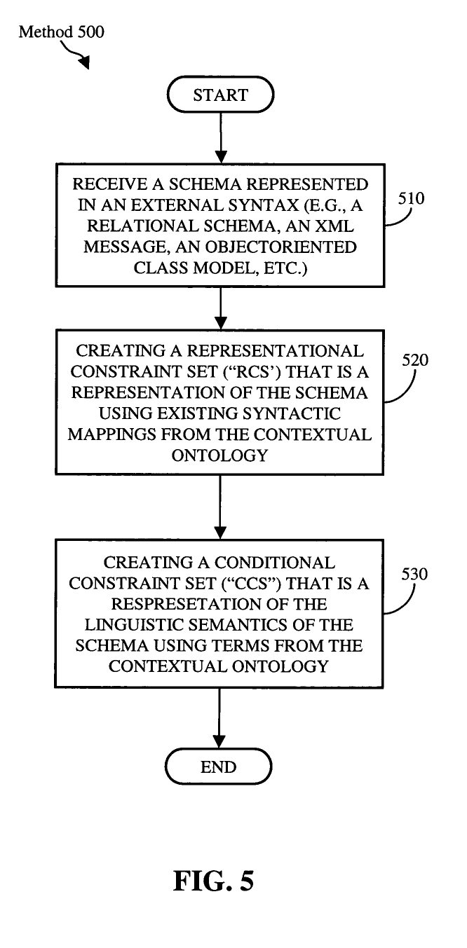

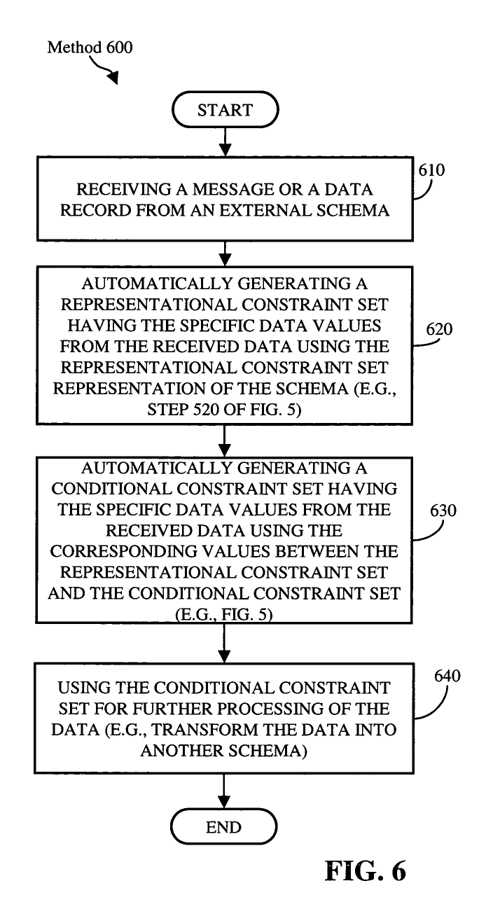

Once a pairing has been achieved between a CCS and an RCS (or a group of Chained RCSs), instance data may be passed between them. Values from a schema can be substituted into an instance of an RCS (as in FIG. 5 above), and these same values them substituted into the CCS with which the RCS shares its values, as in the example below (FIG. 6).

Example of a CCS Including Data Values

This example applies the real values shown in the corresponding RCS (FIG. 5 above) to the CCS:

| | | |
|---|---|---|
| #4 | IsA | JournalArticle |
| #4 | HasTitle | #1.1 |
| #1.1 | HasValue | “Ontological agreement” |
| #1.1 | HasType | #2 |
| #2 | HasValue | xyz:MainTitle |
| #4 | HasAuthor | #5.1 |
| #5.1 | HasName | #3.1 |
| #3.1 | HasValue | “Jill Smith” |

The CCS data is then available for contextual processing using a Contextual Ontology.

FIGS. 5-7 are generalized flow charts illustrating the steps performed in the mapping and transformation of data in accordance with some embodiments of the present invention. It will be understood that the steps shown in these figures may be performed in any suitable order, some may be deleted, and others added.

FIG. 5 is a simplified flow chart illustrating the steps performed in the mapping and representation of schemas in accordance with some embodiments of the present invention. At step 510, the processor may receive a schema represented by an external syntax (e.g., a relational schema, an XML message, an ObjectOriented Class model, etc.). In response, the processor may generate a representational constraint set (“RCS”) that is a representation of the schema using existing syntactic mappings from the contextual ontology at step 520. A representational constraint set may be a set of triples and/or triplesets that express the syntactic structuring and labeling of a group of data elements. The formal semantics used in the representational constraint set may be terms in the contextual ontology that having interpretable formal meaning as a result of prior mappings. For example, the processor may remove the canonical XML syntax from the schema and create a representation of the schema using a tool, such as an XSLT stylesheet. However, it should be noted that any other suitable tool for creating a representation of the schema may also be used.

After generating the representational constraint set, a conditional constraint set (“CCS”) that is a representation of the linguistic semantics of the schema using terms from the contextual ontology may be created at step 530. For example, one skilled in the art may use a processor to create a conditional constraint set. The processor may access a contextual ontology, or a structured data dictionary, which includes ontology terms. The contextual ontology is based on the context model using formal ontological axioms, such as, for example, subsumption, partition, disjunction, classification, and equivalence. Using the ontology terms and axioms, the processor maps the linguistic semantics of the schema are mapped together using the processor into a conditional constraint set.

It should be noted that the values of the representational constraint set and the conditional constraint set correspond for each element. Using corresponding values, employing a technique such as the ArbitraryValue mapping methodology described herein, between the representational constraint set and the conditional constraint set allows the processor to migrate elements from the formal representation of RCS to the semantic representation of CCS. That is, once a pairing has been achieved between the representational and conditional constraint set, instance data may be passed between them. In one example, when receiving data from an external schema, values from the schema may be substituted into an instance of an RCS and these same values may substituted into the CCS with which the RCS shares its values.

FIG. 6 is a simplified flowchart illustrating the steps performed in using the schema mapping to migrate data through a representational constraint set to a conditional constraint set in accordance with some embodiments of the present invention. For example, if the general flow of the present invention is analogized to laying a pipeline and pushing data through that pipeline, FIG. 5 shows the steps for “laying a pipeline” by mapping a schema by, for example, creating specific triple sets, and FIG. 6 shows the steps for “pushing data through the pipeline” by moving data using the mapped schema by, for example, arbitrary value substitution.

At step 610, a message or a data record containing specific data values from an external schema may be received. The external schema may have already been mapped (see, e.g., FIG. 5). Using the mapped schema, the processor generates a representational constraint set having the specific data values from the received data using the representational constraint set representation of the schema (step 620). Thus, when receiving a message from an external schema, values from the schema may be substituted into an instance of a representational constraint set. At step 630, these same values may be substituted into a conditional constraint set with which the representational constraint set shares its values. The conditional constraint set describes the semantic relationships of the data in a schema using the contextual ontology without reference to their representation. For example, a conditional constraint set may be a set of triples describing the semantic relationship that exist between instances.

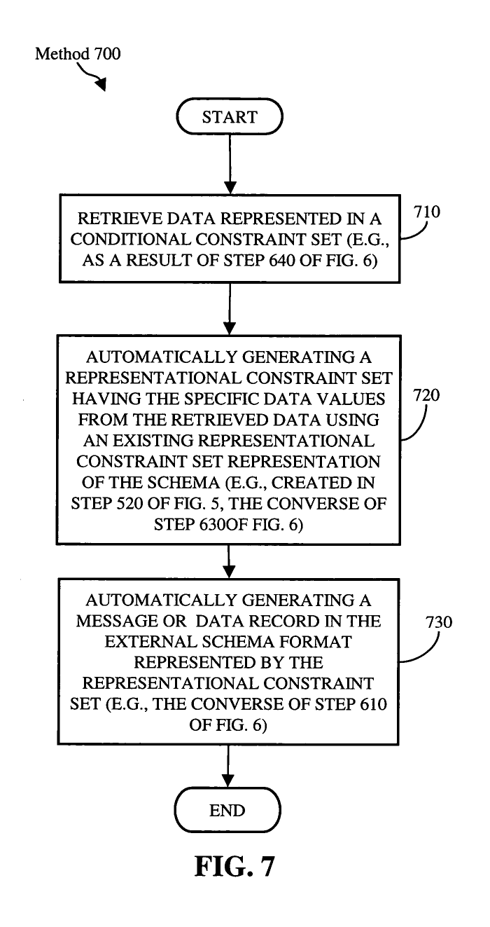

Step 630 generates a conditional constraint set that represents the whole meaning of the statements in the representational constraint set, but it is separated from its specific representation. That is, it may be wholly represented in terms of the semantics of the contextual ontology, using its inherent native syntax, for example, expressed as triples and ArbitraryValues as described above. When the received data values are substituted for ArbitraryValues in the conditional constraint set, the data may be further processed by, for example, any processor capable of understanding the native syntax of the contextual ontology (step 640). For example, the data may be transformed from one schema to another. As a result, the data represented in a different schema may be provided to a user. This is described in further detail in FIG. 7.

FIG. 7 is a simplified flow chart illustrating the steps performed in transforming the schema or the received data to another schema in accordance with some embodiments of the present invention. At step 710, the processor may retrieve data represented in a conditional constrained set. For example, as a result of steps 630 and 640, a conditional constraint set is generated and data values may be substituted for ArbitraryValues in the conditional constraint set. This conditional constraint set having the data values may be retrieved. At step 720, in turn, a representational constraint set having the specific data values from the received data using an existing representational constraint set representation (e.g., created in step 520 of FIG. 5) may be automatically generated. At step 730, a message or data record in the external schema format represented by the representational constraint set is automatically generated. For example, the representational constraint set may be transformed to the different schema using XSLT. Enabling the transformation of data from one schema to another may benefit, for examples, major trading organizations within the media and communications sectors with the requirement to pass semantically rich and complex data from system to system within their organizations, or between organizations irrespective of syntactic portion without losing meaning.

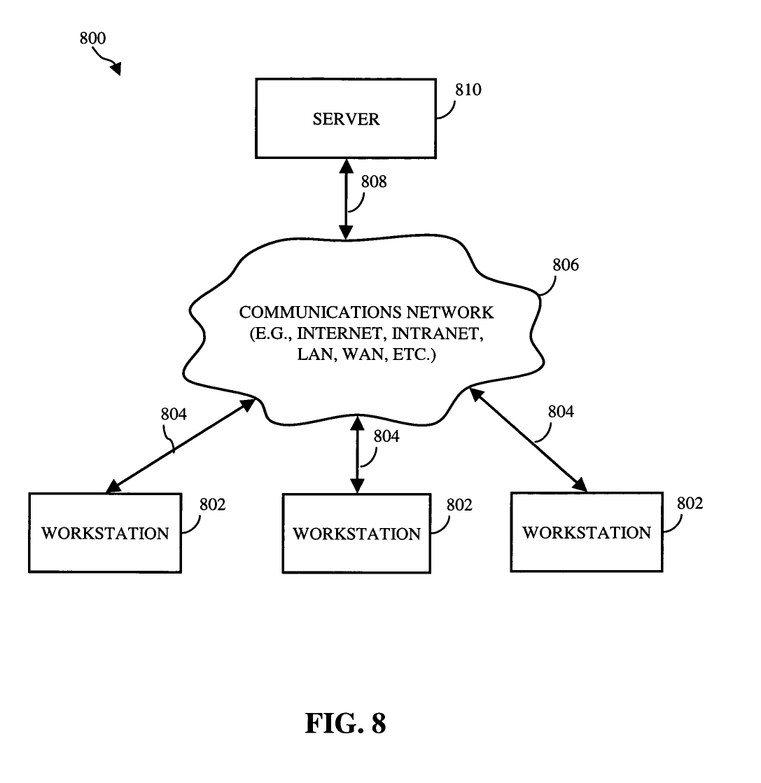

FIG. 8 is a schematic diagram of an illustrative system 800 suitable for implementation of an application that uses the contextual ontology to represent different schemas and/or transform data from one schema to another schema in accordance with some embodiments of the present invention. Referring to FIG. 8, an exemplary system 800 for implementing the present invention is shown. As illustrated, system 800 may include one or more workstations 802. Workstations 802 may be local to each other or remote from each other, and are connected by one or more communications links 804 to a communications network 806 that is linked via a communications link 808 to a server 810.

In system 800, server 810 may be any suitable server for providing access to the application or to the contextual ontology, such as a processor, a computer, a data processing device, or a combination of such devices. Communications network 806 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 804 and 808 may be any communications links suitable for communicating data between workstations 802 and server 810, such as network links, dial-up links, wireless links, hard-wired links, etc. Workstations 802 enable a user to access features using the contextual ontology. Workstations 802 may be personal computers, laptop computers, mainframe computers, dumb terminals, data displays, Internet browsers, personal digital assistants (PDAs), two-way pagers, wireless terminals, portable telephones, etc., or any combination of the same. Workstations 802 and server 810 may be located at any suitable location. In one embodiment, workstations 802 and server 810 may be located within an organization. Alternatively, workstations 802 and server 810 may be distributed between multiple organizations.

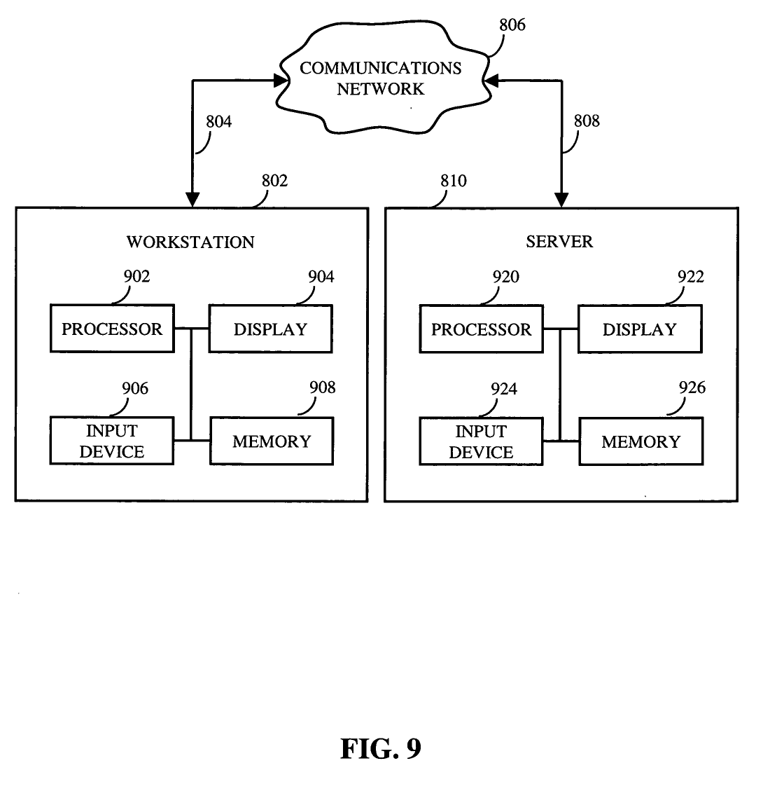

The server and one of the workstations, which are depicted in FIG. 8, are illustrated in more detail in FIG. 9. Referring to FIG. 9, workstation 802 may include processor 902, display 904, input device 906, and memory 908, which may be interconnected. In a preferred embodiment, memory 908 contains a storage device for storing a workstation program for controlling processor 902. Memory 908 also preferably contains the application according to the invention.

In some embodiments, the application may include an application program interface (not shown), or alternatively, as described above, the application may be resident in the memory of workstation 802 or server 810. In another suitable embodiment, the only distribution to the user may be a Graphical User Interface which allows the user to interact with the application resident at, for example, server 810.

In one particular embodiment, the application may include client-side software, hardware, or both. For example, the application may encompass one or more Web-pages or Web-page portions (e.g., via any suitable encoding, such as HyperText Markup Language (HTML), Dynamic HyperText Markup Language (DHTML), Extensible Markup Language (XML), JavaServer Pages (JSP), Active Server Pages (ASP), Cold Fusion, or any other suitable approaches).

Although the application is described herein as being implemented on a workstation, this is only illustrative. The application may be implemented on any suitable platform (e.g., a personal computer (PC), a mainframe computer, a dumb terminal, a data display, a two-way pager, a wireless terminal, a portable telephone, a portable computer, a palmtop computer, a H/PC, an automobile PC, a laptop computer, a personal digital assistant (PDA), a combined cellular phone and PDA, etc.) to provide such features.

Processor 902 uses the workstation program to present on display 904 the application and the data received through communication link 804 and commands and values transmitted by a user of workstation 802. It should also be noted that data received through communication link 804 or any other communications links may be received from any suitable source, such as WebServices. Input device 906 may be a computer keyboard, a cursor-controller, a dial, a switchbank, lever, or any other suitable input device as would be used by a designer of input systems or process control systems.

Server 810 may include processor 920, display 922, input device 924, and memory 926, which may be interconnected. In a preferred embodiment, memory 926 contains a storage device for storing data received through communication link 1908 or through other links, and also receives commands and values transmitted by one or more users. The storage device further contains a server program for controlling processor 920.

It will also be understood that the detailed description herein may be presented in terms of program procedures executed on a computer or network of computers. These procedural descriptions and representations are the means used by those skilled in the art to most effectively convey the substance of their work to others skilled in the art.

A procedure is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in any of the operations described herein which form part of the present invention; the operations are machine operations. Useful machines for performing the operation of the present invention include general purpose digital computers or similar devices.

The present invention also relates to apparatus for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove more convenient to construct more specialized apparatus to perform the required method steps. The required structure for a variety of these machines will appear from the description given.

The system according to the invention may include a general purpose computer, or a specially programmed special purpose computer. The user may interact with the system via e.g., a personal computer or over PDA, e.g., the Internet an Intranet, etc. Either of these may be implemented as a distributed computer system rather than a single computer. Similarly, the communications link may be a dedicated link, a modem over a POTS line, the Internet and/or any other method of communicating between computers and/or users. Moreover, the processing could be controlled by a software program on one or more computer systems or processors, or could even be partially or wholly implemented in hardware.

Although a single computer may be used, the system according to one or more embodiments of the invention is optionally suitably equipped with a multitude or combination of processors or storage devices. For example, the computer may be replaced by, or combined with, any suitable processing system operative in accordance with the concepts of embodiments of the present invention, including sophisticated calculators, hand held, laptop/notebook, mini, mainframe and super computers, as well as processing system network combinations of the same. Further, portions of the system may be provided in any appropriate electronic format, including, for example, provided over a communication line as electronic signals, provided on CD and/or DVD, provided on optical disk memory, etc.

Any presently available or future developed computer software language and/or hardware components can be employed in such embodiments of the present invention. For example, at least some of the functionality mentioned above could be implemented using Visual Basic, C, C++ or any assembly language appropriate in view of the processor being used. It could also be written in an object oriented and/or interpretive environment such as Java and transported to multiple destinations to various users.

It is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Although the present invention has been described and illustrated in the foregoing exemplary embodiments, it is understood that the present disclosure has been made only by way of example, and that numerous changes in the details of implementation of the invention may be made without departing from the spirit and scope of the invention, which is limited only by the claims which follow.

1. A computer implemented method for representing different schemas, the method comprising:
receiving a first schema represented in its native syntax;
distinguishing the semantic portion of the schema from its formal syntactic portion by representing the semantic portion in a first constraint set of the formal syntactic relationships;
accessing a contextual ontology comprising ontology terms;
representing the semantic portion of the received schema in a second constraint set using the contextual ontology; and
determining a second schema responsive to the second constraint set.

2. The method of claim 1, wherein the first schema is one of an XML message schema, a relational database schema, and an ObjectOriented Class model.

3. The method of claim 1, wherein the second schema is one of an XML message schema, a relational database schema, and an ObjectOriented Class model.

4. The method of claim 1, wherein the mapping further comprises:
generating a representational constraint set from the semantic portion that expresses the formal semantics of the first schema using syntactic mappings from the contextual ontology; and
generating a conditional constraint set from the semantic portion that expresses the semantic relationships of the first schema without reference to the formal semantics of the representational constraint set using the ontology terms defined by the contextual ontology.

5. The method of claim 4, wherein the conditional constraint set and the representational constraint set share common variables.

6. The method of claim 1, wherein the ontology terms comprise at least one of an agent term signifying an entity that performs an action relating to the schema, a time term signifying temporal parameters of the schema, a place term signifying spatial parameters of the schema, and a resource term signifying an entity relating to the schema.

7. The method of claim 1, wherein the semantic portion includes at least one of representational semantics, conditional semantics, and unconditional semantics.

8. The method of claim 1, further comprising removing the syntactic portion of the first schema.

9. The method of claim 1, wherein the mapping further comprises using a single contextual ontology without accessing additional structured data dictionaries.

10. The method of claim 1, wherein the mapping further comprises using multiple related ontologies.

11. The method of claim 1, wherein the mapping further comprises using ontologies distributed across a network of systems.

12. The method of claim 1, wherein the determining the second schema embodies the semantic portion in another syntactic schema.

13. A computer implemented method for transforming data represented in one schema to a representation in another schema, the method comprising:
receiving a message or data record of a first schema, wherein the message or data record has data values and wherein the first schema has a representational constraint set representation and a conditional constraint set representation;
generating a representational constraint set having the data values using the representational constraint set representation of the first schema;
generating a conditional constraint set having the data values by using common variables between the representational constraint set representation and the conditional constraint set representation;
correlating the conditional constraint set to a second schema to contextually transfer the message; and
providing the data values represented in the second schema.

14. The method of claim 13, wherein the first schema is one of an XML message schema, a relational database schema, and an ObjectOriented Class model.

15. The method of claim 13, wherein the second schema is one of an XML message schema, a relational database schema, and an ObjectOriented Class model.

16. The method of claim 13, wherein the generating the representational constraint set comprises substituting the data values into the representational constraint set representation.

17. The method of claim 13, further comprising accessing a contextual ontology comprising ontology terms.

18. The method of claim 17, wherein the ontology terms comprise at least one of an agent term signifying an entity that performs an action relating to the data, a time term signifying temporal parameters of the data, a place term signifying spatial parameters of the data, and a resource term signifying an entity relating to the data.

19. The method of claim 13, further comprising using a single contextual ontology without accessing additional structured data dictionaries.

20. The method of claim 13, further comprising using multiple related ontologies.

21. The method of claim 13, further comprising using ontologies distributed across a network of systems.

22. The method of claim 13, wherein the conditional constraint set and the representational constraint set share common variables.

23. The method of claim 13, wherein the correlating the conditional constraint set to the second schema preserves the full meaning of the message.

24. The method of claim 13, wherein the correlating the conditional constraint set to the second schema embodies the semantic portion in another syntactic schema.

25. A computer implemented method for representing different schemas within a formal ontology, the method comprising:
receiving a given schema represented in a syntax;
accessing a contextual ontology comprising ontology terms; and
generating a representational constraint set from the received schema that expresses the formal semantics of the schema using syntactic mappings defined by the contextual ontology; and
generating a conditional constraint set from the received schema that expresses the semantic relationships of the schema without reference to the formal semantics of the representational constraint set using ontology terms defined by the contextual ontology, wherein the conditional constraint set and the representational constraint set share common variables.

26. The method of claim 25, wherein the given schema is one of an XML message schema, a relational database schema, and an ObjectOriented Class model.

27. The method of claim 25, wherein the ontology terms comprises at least one of an agent term signifying an entity that performs an action relating to the schema, a time term signifying temporal parameters of the schema, a place term signifying spatial parameters of the schema, and a resource term signifying an entity relating to the schema.

28. The method of claim 25, further comprising using a single contextual ontology without accessing additional structured data dictionaries.

29. The method of claim 25, further comprising using multiple related ontologies.

30. The method of claim 25, further comprising using ontologies distributed across a network of systems.

31. A data processing system for representing different schemas, the system comprising:
means for receiving a first schema represented in its native syntax;
means for distinguishing the semantic portion of the schema from the syntactic portion;
means for accessing a contextual ontology comprising ontology terms;
means for mapping the semantic portion of the received schema to a constraint set using the contextual ontology; and
means for determining a second schema responsive to the constraint set.

32. A data processing system for representing different schemas, the system comprising:
a display device; and
a processor configured to:
receive a first schema represented in its native syntax;
distinguish the semantic portion of the schema from the syntactic portion;
access a contextual ontology comprising ontology terms;
map the semantic portion of the received schema to a constraint set using the contextual ontology; and
determine a second schema responsive to the constraint set.
